(19) United States
(12) Patent Application Publication
(10) Pub. No.: US 2014/0081203 A1
(43) Pub. Date: Mar. 20, 2014

(54) CONTAINER FOR ADMINISTERING MEDICATION

(71) Applicants: Shuji Morimoto, Osaka-shi Osaka (JP); Masao Nozaki, Osaka-shi Osaka (JP); Naomi Kurata, Fujisawa-shi Kanagawa (JP)

(72) Inventors: Shuji Morimoto, Osaka-shi Osaka (JP); Masao Nozaki, Osaka-shi Osaka (JP); Naomi Kurata, Fujisawa-shi Kanagawa (JP)

(73) Assignee: MORIMOTO-PHARMA CO., LTD., Osaka (JP)

(21) Appl. No.: 14/115,069

(22) PCT Filed: May 1, 2012
(86) PCT No.: PCT/JP2012/061523

§ 371 Date: Oct. 31, 2013

(30) Foreign Application Priority Data
May 2, 2011 (JP) PCT/JP2011/060539

(51) Int. Cl. A61J 7/00; A61J 1/10

(52) U.S. Cl. CPC A61J 7/0007; A61J 1/10
USPC 604/82

(57) ABSTRACT

In order to reduce the labor associated with the administration of a medication or the like to a patient via a tube, while ensuring that the medication can be administered with at least the same degree of safety and accuracy as in the past, a container for administering a medication is provided with a storage section and a discharge section. The storage section has an inlet. The container for administering a medication is further provided with a sealing part. The sealing part seals the boundary section between the storage section and the discharge section, and opens the boundary section when the storage part is subjected to a force of a prescribed magnitude or greater while a mixture is stored therein. The discharge section can be connected to a tube. In addition to the inlet, the storage section is also provided with an inlet opening/closing part.

### TECHNICAL FIELD

This invention relates to a container for administering medication, specifically, a container for administering medication that reduces the labor for administering medicine or the like to a patient through a nasogastric tube, gastric fistula, intestinal fistula or other enteral nutrition equipment (hereinafter simply referred to as “tube”).

### BACKGROUND ART

When administering medicine or the like to a patient via a tube, the following procedure used to be taken before. In the first step, the pharmacist or care provider pulverizes a tablet or opens a capsule to take out the medicine. In the second step, the medicine obtained by pulverizing the tablet or the medicine taken out of the capsule is suspended in water. In the third step, the suspension obtained in the second step is injected from the tube. In the following explanations, this method is referred to as “medication by pulverization”.

Medication by pulverization has, among others, the problems that 1) there is a significant loss of the medicine, 2) the pharmacist or care provider is exposed to the medicine, 3) the quality of the medicine is lost, and 4) the QoL (Quality of Life) of the patient is reduced due to the clogging of the tube. The problem 1) occurs because powder adheres to the pulverization device or wrapping paper when the tablet is pulverized, and because medicine remains inside the container or the like during the administration thereof (that the medicine remains inside the container or the like is because the medicine is hydrophobic and thus does not mix with water). The problem 2) occurs when the pharmacist aspirates the medicine when pulverizing the tablet or taking out the medicine from the capsule, and when the care provider aspirates the medicine during the time until the medicine is suspended. The problem 3) occurs when it becomes impossible to maintain the stability of the medicine due to light and humidity when the tablet or capsule is taken out of the wrapping and pulverized or decapsulated. The problem 4) occurs because the medicine from the pulverized tablet or the medicine taken out from the capsule does not pass through the tube.

“Pulverizing medicine for patients with swallowing disorders” is ordinary practice and has hardly been doubted at all. If no liquid or powder preparation is available, pharmacists and care providers pulverize a tablet or take out medicine from a capsule to prepare a powder, and, to administer the medicine, suspend the medicine in water and inject the medicine through a tube. However, because the medicine has been prepared and administered without any information available with regard to “what happens when the drug is suspended in water”, the problems such as the clogging of the tube, losses in the administered quantities and the many other problems that were occurring had not been recognized although the problems occurred. Naomi Kurata one of the inventors of this application, learnt from a nurse over the telephone that a gastric fistula became clogged when a drug was being given in 1996. The clogging of the tube was caused by a granular preparation that had been changed upon an inquiry to a doctor by a pharmacist doubting a prescription for pulverizing a tablet. Thinking that a drug prepared by a pharmacist must not clog a tube, Naomi Kurata started to research on methods for the tubal administration of drugs. After having gone through various stages, the simplified suspension method was created.

Patent document 1 discloses a method for producing a medical-use drug solution enclosure, and a container therefor. For the production of a medical-use drug solution enclosure wherein a medical-use drug solution is enclosed in a flexible container equipped with a spout, a step of sealing the spout by a plug after having filled in the drug solution is eliminated, the growing complexity of the mechanism of the drug solution filling equipment is overcome and the process for tightly sealing the container after the drug solution was filled into the container is simplified. Patent document 2 discloses an agent for the preparation of viscous drug and a viscous medicine preparation product. Provided is a viscous medicine which can easily be swallowed even by a person with swallowing function disorders, can be prepared in a viscous state easily and in a short time, and can be preserved for a long time. Patent document 3 discloses a packaging material and a packaging container using same. The invention relates to a packaging material wherein an air-permeable transparent hole is disposed at a predetermined position on a plastic film single layer or a laminated material including same, and an air-permeable base material is superposed and laminated at least to the portion comprising the above-mentioned air-permeable transparent hole, and relates to a packaging container using same.

Non-patent document 1 discloses the simplified suspension method. The simplified suspension method is carried out according to the following procedure. First, a tablet or capsule is placed inside a container or directly into the injection device. Next, warm water of a temperature of approximately 55 degrees Celsius is filled into the container or injection device. Then, same is left to cool naturally for up to 10 minutes for the tablet or the like to crumble and become suspended in the warm water. If a container is used, the suspension containing the crumbled tablet or the like is sucked into an injection device. Next, the injection device containing the suspension is connected to the tube. At the end, the suspension in the injection device is administered to the patient through the tube.

The simplified suspension method disclosed in non-patent document 1 is able to solve, among others, the problems that 1) there is a significant loss of medicine, 2) the pharmacist or care provider is exposed to the medicine, 3) the quality of the medicine is lost, and 4) the QoL of the patient is reduced due to the clogging of the tube. Further, the simplified suspension method is able to significantly reduce the risk of tube clogging.

### PRIOR ART DOCUMENTS

### Patent Documents

Patent document 1: Japanese patent publication JP 2010-94540
Patent document 2: Japanese patent publication JP 2003-137817
Patent document 3: Japanese patent publication JP 10-218250

### Non-Patent Documents

Non-patent document 1: KURATA, Naomi, “Enge shogai no aru kanja-san he no fukuyaku shien, kan'i kendaku-ho [Assistance for the ingestion of medicine by patients with swallowing disorders, Simplified suspension method]”, [online], 2010, Showa University, School of Pharmacy, Laboratory of Pharmaceutical Sciences, [21 Apr. 2011], Internet <URL:http://www10.showa-u.ac.jp/˜biopharm/kurata/kendaku/index.html>

### BRIEF SUMMARY OF THE INVENTION

### Problem to be Solved by the Invention

The simplified suspension method disclosed in non-patent document 1 leaves room for improvement with respect to labor. For example, for the simplified suspension method, the tablet and capsule need to crumble and become suspended in the container over a time of up to 10 minutes after warm water of 55 degrees Celsius was poured into the container. If the tablet or capsule does not crumble and become suspended after 10 minutes since the warm water of 55 degrees Celsius was poured into the container, the pharmacist or nurse must take various measures to cause the tablet or capsule to crumble and become suspended. Even if the tablet did crumble and become suspended, pouring the warm water into the injection device and cleaning the injection device after use means a large amount of work.

The technical issue addressed by this invention is to solve the above-mentioned problems, and the purpose thereof is to administer medicine through a tube to a patient with the same or a better safety and reliability than before, and to reduce the labor for administering the medicine.

### Means for Solving the Problem

The container for administering medication of this invention is explained in reference to the drawings. Note that the use of the reference numerals of the drawings in this column is intended to facilitate the understanding of the content of the invention and is not intended to limit the content to the scope indicated.

According to the aspects of this invention to achieve the above-mentioned purpose, the containers for administering medication 10, 60, 90, 100 and 120 are provided with a storage section 30 and a discharge section 32. The storage section 30 has an inlet 46 for a medicine and a liquid. The discharge section 32 is able to discharge a mixture of the medicine and the liquid. The containers for administering medication 10, 60, 90, 100 and 120 are further provided with sealing sections 34, 74, 104 and 134. The sealing sections 34, 74, 104 and 134 seal the boundary portion between the storage section 30 and the discharge section 32. The sealing sections 34, 74, 104 and 134 open the boundary portion when the storage section 30 storing the mixture receives a force of at least a predetermined strength. The discharge section 32 can be connected to a tube 58. The storage section 30 has an inlet opening/closing section 36 in addition to the inlet 46. The inlet opening/closing section 36 opens and closes the inlet 46. The storage section 30 is formed of a material that allows the application of concentrated external force to the medicine in the mixture when the mixture is stored. Note that the term “medicine” in this invention refers to a medicine as defined in the Pharmaceutical Affairs Law of Japan, as well as to substances that are sometimes given to humans with the purpose of at least one of the therapy and the prophylaxis of human diseases.

The inlet of the storage section 30 is opened by means of the inlet opening/closing section 36, and the medicine and the liquid are stored in the storage section 30. When the medicine and liquid are stored in the storage section 30, the inlet 46 of the storage section 30 is closed by means of the inlet opening/closing section 36. When the inlet 46 of the storage section 30 is closed, the containers for administering medication 10, 60, 90, 100 and 120 are left to stand, to let the medicine crumble and become suspended in the liquid. If the medicine does not completely crumble and/or is not completely suspended, it is possible to pick up the medicine between the fingers and disperse the medicine in the liquid. If a tablet does not crumble just by leaving the containers for administering medication 10, 60, 90, 100 and 120 to stand, concentrated external force is applied to the medicine to cause cracks in the surface of the medicine. As a result, water will penetrate into the medicine, and the medicine will crumble. When the medicine crumbled and became suspended in the liquid, the connector 40, which is located at the discharge section 32, is connected to the tip of the tube 58. When the discharge section 32 is connected to the tip of the tube 58, a force of at least a predetermined strength is applied to the storage section 30. As a result, the sealing sections 34, 74, 104 and 134 open the boundary portion between the storage section 30 and the discharge section 32. As the boundary portion opens, the mixture in the storage section 30 flows out through the discharge section 32 into the tube 58.

In a procedure above, concentrated external force is applied to the medicine to cause cracks in the surface of the medicine if the medicine does not crumble and become suspended in the liquid. As a result, the medicine will crumble and become suspended. Because the storage section 30 communicates through the discharge section 32 with the tube 58, it is not necessary to let the mixture in the storage section 30 crumble and become suspended in another container in advance. Because it is not necessary to let the mixture crumble and become suspended in another container in advance, the work of transferring the suspension from that container into the injection device becomes unnecessary. Because the work of transferring the mixture into the injection device is unnecessary, the work of cleaning the container also becomes unnecessary. Moreover, because the sealing sections 34, 74, 104 and 134 seal the boundary portion between the storage section 30 and the discharge section 32 until a force of at least a predetermined strength is applied to the storage section 30, it is not necessary to worry that the mixture may leak when the connector 40, which is on the discharge section 32, is connected to the tube 58. Further, because the storage section 30 is formed of a material that allows the application of concentrated external force to the medicine, it is naturally easy to push out the mixture from there into the tube 58 by applying force to the storage section 30. As a result, it is possible to reduce the labor for administering medicine or the like to a patient through the tube 58.

Further, it is preferable that the above-mentioned boundary portion between the storage section 30 and the discharge section 32 has a portion that is formed from sheets 20 and 20 that face each other. In this case, the fusion-bonded section 80, which is the first sealing section of the sealing section 74, the fusion-bonded section 110, which is the first sealing section of the sealing section 104, and the sealing section 134 seal the boundary portion between the storage section 30 and the discharge section 32 by means of the fusion bonding of the surfaces of two sheets 20 facing each other. The backup section 82, which is the second sealing section of the sealing section 74 and the backup section 112, which is the second sealing section of the sealing section 104, are positioned further toward the discharge section 32 side than the sealing sections 74 and 104 and maintain the boundary portion in a sealed state.

If the backup sections 82 and 112 are provided, it is possible to keep the sealed state of the boundary portion even if apart of the fusion bond of the sealing sections 74 and 104 becomes detached because the medicine in the mixture has received concentrated external force. Because it is possible to maintain the sealed state of the boundary portion, it is possible to prevent the mixture from passing through the boundary portion. Compared to the case wherein no backup sections 82 and 112 are provided, this will reduce the possibility that it becomes necessary to take measures against the partial detachment of the fusion bond of the sealing sections 74 and 104 that occurred because the medicine in the mixture received concentrated external force. Because such possibility is reduced, it is possible to reduce the labor for administering medicine or the like to the patient.

Otherwise, it is preferable that the above-mentioned backup section 82 has a zipper tape.

If the backup section 82 has a zipper tape, it is possible to keep the sealed state of the boundary portion even if apart of the fusion bond of the sealing section 74 becomes detached because the medicine in the mixture received concentrated external force, and even if the zipper tape should come open, it is possible to close the zipper tape again. As a result, it is possible to seal the boundary portion again even if the backup section 82 becomes temporarily unable to maintain the sealed state of the boundary portion. As a result, it is possible to stop the outflow of the mixture even in the event that the mixture flows out of the container for administering medication 60 against the will of the user of the container for administering medication 60. Because it is possible to stop the outflow of the mixture, the possibility that the mixture flows out of the discharge section 32 is reduced as compared to the case wherein it is not possible to stop the outflow of the mixture. Because the possibility that the mixture flows out of the discharge section 32 is reduced, it is possible to reduce the labor for administering medicine or the like to the patient.

Otherwise, it is preferable that the above-mentioned inlet opening/closing section 36 has a zipper tape.

### Effect of the Invention

According to this invention, it is possible to administer medicine through a tube to a patient with the same or a better safety and reliability than before, and to reduce the labor for administering the medicine.

### BRIEF DESCRIPTION OF THE DRAWINGS

FIG. 1 is a partial cross section of the container for administering medication of the first embodiment of this invention.

FIG. 2 shows how the container for administering medication of the first embodiment of this invention is used.

FIG. 3 is a partial cross section of the container for administering medication of the first alternative example of this invention.

FIG. 4 is a partial cross section of the container for administering medication of the second alternative example of this invention.

FIG. 5 is a partial cross section of the container for administering medication of the second embodiment of this invention.

FIG. 6 shows the test results for the container for administering medication of the second embodiment of this invention.

FIG. 7 is a partial cross section of the container for administering medication of the third embodiment of this invention.

FIGS. 8A and 8B show how the container for administering medication of the third embodiment of this invention is stored.

FIGS. 9A and 9B show how the container for administering medication of the third embodiment of this invention is stored.

FIG. 10 shows how the container for administering medication of the third embodiment of this invention is stored.

### MODES FOR CARRYING OUT THE INVENTION

The following explains the embodiments of this invention on the basis of the drawings. In the following explanations, identical parts are assigned the same reference numeral. The names and functions thereof are also the same. Accordingly, detailed explanations thereof will not be repeated.

### First Embodiment

The following explains the first embodiment of this invention.

### Explanation of the Structure

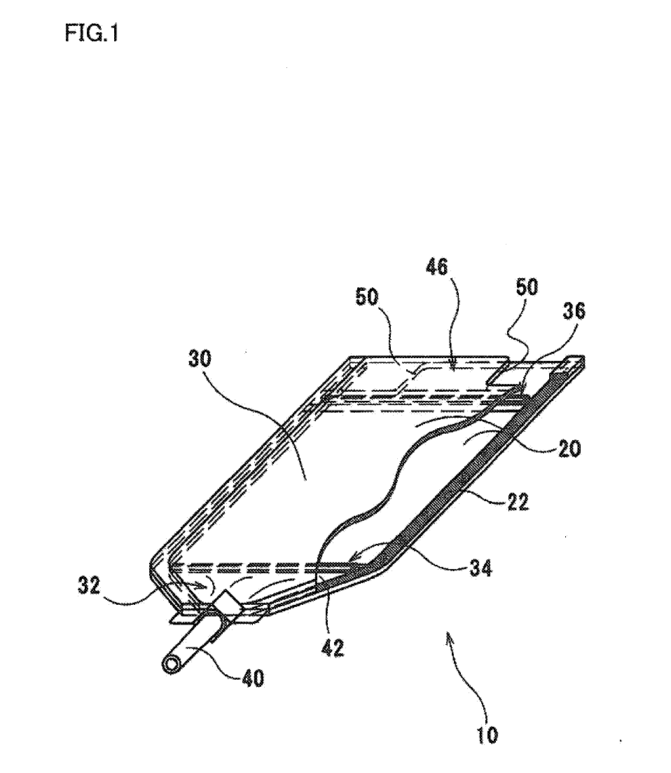

The structure of the container for administering medication 10 of this embodiment will be explained while referring to FIG. 1. The container for administering medication 10 of this embodiment is formed by superposing the two sheets 20 and 20 on each other and bonding the outer circumferences 22 thereof to each other firmly in such a manner that the sheets do not easily become detached from each other. The total length is approximately 100-170 millimeters, and the width is approximately 80 millimeters. On a side note, in the case of this embodiment, the outer circumferences 22 do not detach from each other even if a force of 40 Newton is applied.

The sheets 20 and 20 are made of a material that satisfies the following requirements. The first requirement is flexibility. Specifically, the flexibility should allow the application of concentrated external force to the medicine in the mixture when the mixture of the medicine and warm water is stored in the container for administering medication. The second requirement is that even if warm water of a temperature of 55 degrees Celsius is stored, the components do not elute into the warm water. The third requirement is that the material should be transparent with color and/or transparent without color.

To satisfy those requirements, the sheet 20 of this embodiment is a composite material comprising three layers. In this embodiment, the layers are referred to as “welding layer”, “hermetic seal layer” and “strength layer”. The welding layer is the surface that melts when the sheets 20 are bonded to each other. The sheets 20 are fusion-bonded as the welding layer melts. In the case of this embodiment, the material of the welding layer is polyethylene. The thickness is 40-60 μm. The hermetic seal layer prevents moisture and the like from passing through. In the case of this embodiment, the material of the hermetic seal layer is polyethylene terephthalate. The thickness is 10-20 μm. The strength layer receives the load applied to the container for administering medication 10. In the case of this embodiment, the material of the strength layer is nylon. The thickness is 10-20 μm. Of course, the material of the sheet 20 is not limited to the materials mentioned here.

The container for administering medication 10 has a storage section 30, a discharge section 32, a sealing section 34 and an inlet opening/closing section 36 formed therein.

The storage section 30 is able to store a mixture of the medicine, warm water and other liquid. The discharge section 32 is able to discharge the above-mentioned mixture. However, in the case of this embodiment, the medicine and warm water are not in the storage section 30 until the container for administering medication is used. Note that the storage section 30 has an inlet 46. The inlet 46 is positioned on the end of the storage section 30. The inlet 46 serves as the inlet for the medicine, warm water and other liquid to the storage section 30. The sealing section 34 is disposed on the boundary portion between the storage section 30 and the discharge section 32. The sealing section 34 seals the boundary portion. As a result, the movement of the above-mentioned mixture from the storage section 30 to the discharge section 32 will be blocked. The sealing section 34 opens the boundary portion when the storage section 30 storing the mixture receives a force of at least a predetermined strength. The inlet opening/closing section 36 opens and closes the inlet 46 of the storage section 30.

As mentioned above, the container for administering medication 10 of this embodiment is formed by bonding the outer circumferences 22 of the two sheets 20 and 20 to each other. Therefore, the inlet 46 is formed by superposing the above-mentioned sheets 20 and 20 on each other and bonding the ends thereof to each other. In the case of this embodiment, the inlet section 46 is provided with cut-outs 50. In the case of this embodiment, one cut-out 50 is provided on one sheet 20. In the case of this embodiment, the cut-outs 50 are disposed so as not to face each other. As a result, it is possible to easily insert a finger into the inlet 46.

The discharge section 32 has a connector 40 and an empty chamber 42. The connector 40 is connected to the tube 58, which will be mentioned later (on aside note, the connector 40 is sometimes connected to the tube 58 through a known three-way stopcock). The empty chamber 42 is adjacent to the sealing section 34. The empty chamber 42 serves as a passage for above-mentioned mixture when the mixture is discharged through the connector 40 to the outside of the container for administering medication 10. The connector 40 can be connected to the tube 58, which will be mentioned later. As a result, the discharge section 32 can also be connected to the tube 58.

In the case of this embodiment, the sealing section 34 is composed of a zipper tape. The structure of zipper tapes itself is known, but make sure, an outline will be explained below. A zipper tape is composed of a pair of members. One of the members has a groove provided therein. The other has a linear protrusion provided thereon. The protrusion of the latter enters the groove of the former. These members are bonded to the above-mentioned boundary portion of the sheets 20 and 20. As a result, it becomes possible to open or close the above-mentioned boundary portion. In the case of this embodiment, the zipper seal opens if a force of 2 to 15 Newton is applied.

In the case of this embodiment, the inlet opening/closing section 36 is also composed of a zipper tape. In the case of this embodiment, the zipper tape constituting the inlet opening/closing section 36 is more leak-resistant than the zipper tape constituting the sealing section 34. More specifically, this zipper tape can be opened with a force of 5-30 N/50 mm from the inlet 46 side and a force of 40-80 N/50 mm from the storage section 30 side. In this way, the zipper tape can be opened with a relatively weak force from the inlet 46 side but only with a relatively strong force from the storage section 30 side. As a result, it is possible to configure in such a manner that the zipper tape easily opens from the inlet 46 side to facilitate filling the mixture into the storage section 30 from the inlet 46, but does not easily open from the storage section 30 side to inhibit a leakage of the liquid stored in the storage section 30. (This zipper tape may open when a force from 20-100 Newton is applied.)

### Explanation of the Usage Method

The following explains how to use the container for administering medication 10 of this embodiment. Note that the zipper tape of the sealing section 34 of the container for administering medication 10 is normally closed.

First, the nurse receives, from the pharmacist, a plurality of medicine-containing bags that have the name of the respective patient written thereon. Some of the medicine-containing bags contain a medicine that can be filled as-is into the container for administering medication 10. Some of the other medicine-containing bags contain a medicine that needs to have cracks formed on the surface film thereof. The nurse inserts a finger into the cut-out 50 and expands the inlet 46. When the inlet 46 is expanded, the nurse opens the zipper tape of the inlet opening/closing section 36. When the zipper tape of the inlet opening/closing section 36 is open, the nurse fills the medicine from the inlet 46 into the storage section 30. The medicine filled into the storage section 30 at this time is the medicine that needs to have cracks formed on the surface film thereof.

When the medicine enters the inside of the storage section 30, the nurse lightly hits the medicine from the outside of the container for administering medication 10 with a hard stick-like object or a dedicated tool in order to form cracks in the surface film of the medicine. When cracks are formed in the surface film of the medicine, the nurse fills the above-mentioned medicine that can be filled as-is into the container for administering medication 10, into the storage section 30. When all of the medicine is in the storage section 30, the nurse closes the zipper tape of the inlet opening/closing section 36. Note that the opening of the inlet 46 of the container for administering medication 10 of this embodiment is larger than the opening of a conventional container. Because the opening is large, the possibility that medicine is spilled is significantly lower with the container for administering medication 10 of this embodiment compared to the case wherein a conventional container is used. Because the possibility that the medicine is spilled is low, a nurse can transfer a powdery medicine that easily scatters without becoming exposed to the powdery medicine.

Next, the nurse in the kitchenette or the like opens the zipper tape of the inlet opening/closing section 36. When the zipper tape of the inlet opening/closing section 36 opens, the nurse inserts a finger into the cut-out 50 and expands the inlet 46. When the inlet 46 is expanded, the nurse fills warm water of a temperature of approximately 55 degrees Celsius into the storage section 30. If, at this time, there is concern that the warm water may leak out from the sealing section 34, the discharge section 32 may be folded along the sealing section 34 and clamped with a binder clip or the like. When the warm water is in the storage section 30, the nurse closes the zipper tape of the inlet opening/closing section 36 and leaves the container for administering medication 10 for up to ten minutes. If the tablet or other medicine has not crumbled and has not become suspended even after 10 minutes passed, the nurse can knead or shake the medicine from the outside of the container for administering medication 10 as appropriate. As a result, the medicine in the storage section 30 crumbles and becomes suspended in the warm water, and the temperature of the warm water gradually falls.

While the container for administering medication 10 is left standing, the medicine in the storage section 30 crumbles and becomes suspended in the warm water.

After some minutes, the nurse checks whether the medicine in the storage section 30 still has the form of a block. If the medicine still has the form of a block, the nurse applies concentrated external force to the block-like medicine from the outside of the storage section 30. The specific method for applying the external force is not particularly limited. One method for applying concentrated external force to the medicine is that the nurse presses the entire storage section 30 with his or her fingers. As a result, the medicine in the storage section 30 crumbles and becomes suspended.

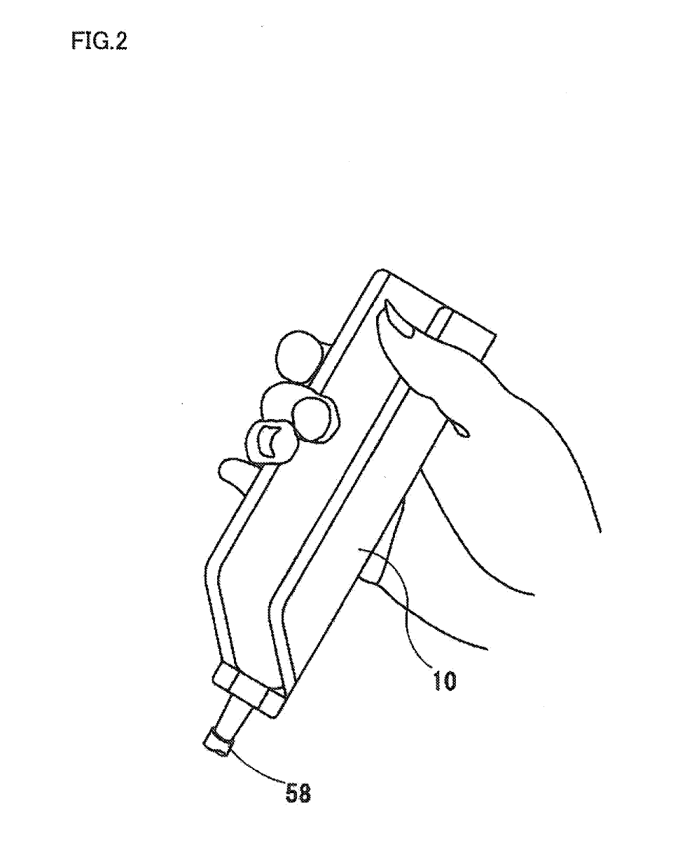

When warm water of a temperature of approximately 55 degrees Celsius is left to stand for 10 minutes, the temperature of the mixture of the medicine and warm water will approach the body temperature of humans. As a result, the mixture will be in a state that is suitable for the administration to the patient. When 10 minutes passed after the medicine and the warm water were filled into the container for administering medication 10, the nurse connects the connector 40 of the container for administering medication 10 to the tube 58, as depicted in FIG. 2. The tube 58 is a nasogastric tube, gastric fistula, intestinal fistula or the like, which is not shown in the drawings, and reaches into the stomach or intestines of the patient.

When the container for administering medication 10 is connected to the tube 58, the nurse folds the container for administering medication 10 into two and grips the container for administering medication 10 as depicted in FIG. 2. As mentioned above, the storage section 30 is formed of a material that allows the application of concentrated external force to the medicine. As a result, pressure is applied to the above-mentioned mixture when the container for administering medication 10 is gripped. The mixture that received the pressure applies pressure to the sealing section 34. The sealing section 34 that received the pressure opens. As a result, the mixture in the storage section 30 is squeezed out of the storage section 30. At this time, the inlet opening/closing section 36 may be clamped with a binder clip as mentioned above to further lower the risk that the mixture leaks.

The mixture that was squeezed out is injected into the body of the patient through the discharge section 32 and the tube 58. After the nurse has injected the medicine into the body of the patient, the nurse disconnects the container for administering medication 10 from the tube 58. The disconnected container for administering medication 10 is discarded. The container for administering medication 10 may be cut into small pieces with scissors.

Further, the container for administering medication 10 of this embodiment is made of a flexible material. Because the container for administering medication 10 is made of a flexible material, it is possible to place the container for administering medication 10 into a box after having folded the container for administering medication 10, or to store the container for administering medication 10 in the pocket of a calendar.

Further, the inlet opening/closing section 36 of the container for administering medication 10 of this embodiment is composed of a zipper tape. As a result, it is possible to repeat the opening and closing with roughly the same force. No force is required as in the case when opening a bottle cap that was screwed close too tightly.

### Explanation of the Effect

In the above-mentioned way, according to the container for administering medication 10 of this embodiment, it is possible to reduce the labor for administering medicine or the like to a patient through the tube 58.

### Second Embodiment

The following explains the second embodiment of this invention.

In the container for administering medication 10 of the aforementioned first embodiment, the sealing section 34 was composed of a zipper tape. Meanwhile, the container for administering medication 100 of this embodiment has a sealing section 134 wherein the surfaces of sheets 20 that face each other are heat-fusion bonded to each other. In the explanations below, features which are the same as those explained in the first embodiment are given identical reference numerals. Further, detailed explanations of features which are the same as those explained in the first embodiment will be skipped.

1. Features

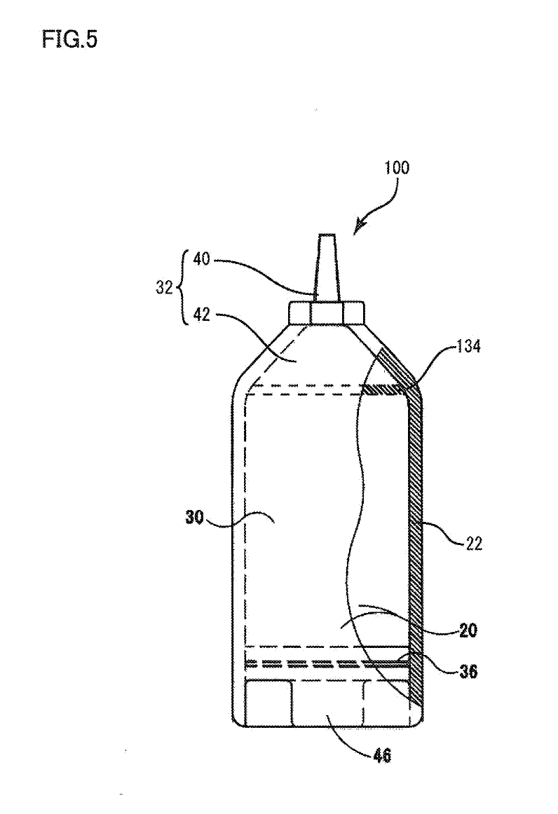

The container for administering medication 100 will be explained using FIG. 5. The container for administering medication 100 has a sealing section 134. The sealing section 134 is disposed on the boundary portion between the storage section 30 and the discharge section 32 in the same way as the sealing section 34 in the container for administering medication 10. The other features are the same as those of the first embodiment.

2. Sealing Section 134

The following explains the sealing section 134 in detail.

(1) Formation Method

As mentioned above, the sealing section 134 is formed by fusion-bonding the surfaces of sheets 20 which face each other. For this kind of fusion bonding, a method such as that disclosed in the Japanese patent document 2006-52013, 2007-222292 or 1999-377 may be used.

(2) Fusion Bond Strength

Next, the strength of the fusion bond of the surfaces of sheets 20 which face each other of the sealing section 134 (hereinafter referred to as fusion bond strength) will be explained.

To determine the fusion bond strength of the sealing section 134, the following tests were conducted. The sheets 20 used for the tests had the structure shown in Table 1.

TABLE 1

| Laminate | | |
|---|---|---|
| layer | Thickness | Material resin name |
| Strength | 15 μm | Nylon (NY) |
| layer | | |
| Hermetic | 12 μm | Polyethylene |
| seal layer | | terephthalate (PET) |
| Welding | 50 μm | Polyethylene (PE) |
| layer | | |

1) Samples wherein the seal strength of the sealing section 134 was 1.0-8.0 N/15 mm were produced at increments of 0.2 N/15 mm.

2) The samples were filled with liquid, pressure was applied to the storage section 30, and it was checked how easy or difficult it was to break the sealing section 134.

3) For the fusion bonding in the sealing section 134, it was evaluated 1: how easy it is to break the fusion bond and 2: how difficult it is to break the fusion bond, with the scores being very good (A), good (B), neither good nor bad (C), and bad (D).

4) The samples were filled with liquid, and it was checked whether the fusion bond of the sealing section 134 smoothly breaks and the liquid can be smoothly discharged when the storage section 30 is squeezed with gripping force.

5) 3: It was evaluated whether the fusion bond of the sealing section 134 smoothly breaks and the liquid can be smoothly discharged when the storage section 30 is squeezed with gripping (usage suitability), with the scores being very good (A), good (B), neither good nor bad (C), and bad (D).

6) On the basis of 1: how easy it is to break the bond, 2: how difficult it is to break the bond and 3: the usage suitability, a general evaluation was made.

Note that the fusion bond strength of the sealing section 134 was measured according to JIS Z 0238, “Testing methods for heat-sealed flexible package bags and semi-rigid containers”, “7. Heat-seal strength tests of bags”.

Based on the results of these tests, the samples were given a general score having nine ranks, from 1 to 9.

TABLE 2

| 1: | 2: | | | | | |
|---|---|---|---|---|---|---|
| Evaluation | Evaluation | | | | | |
| of the ease | of the | | 3: | | | |
| of breaking | difficulty of | | Evaluation | | | |
| the fusion | breaking the | | of usage | | General | Evaluation |
| bond | fusion bond | Explanation | suitability | Explanation | evaluation | score |
| A | D | Breaks when only | — | (not usable) | D | 1 |
| | | filled extremely | | | | |
| | | lightly | | | | |
| A | D | Leakage after | — | (not usable) | D | 2 |
| | | leaving a lightly | | | | |
| | | filled bag for 30 | | | | |
| | | minutes | | | | |
| A | C | No leak even | — | (not usable) | C | 3 |
| | | when applying | | | | |
| | | light pressure to | | | | |
| | | the filled bag | | | | |
| B | B | No leak even | A | Could be | A | 4 |
| | | when applying | | squeezed out | | |
| | | light pressure to | | properly with | | |
| | | the filled bag | | gripping force | | |
| B | B | No leak even | A | Could be | A | 5 |
| | | when applying | | squeezed out | | |
| | | normal pressure | | properly with | | |
| | | to the filled bag | | gripping force | | |
| B | B | No leak even | B | Could be | B | 6 |
| | | when applying | | squeezed out | | |
| | | normal pressure | | sufficiently | | |
| | | to the filled bag | | with rather | | |
| | | | | strong | | |
| | | | | gripping force | | |
| C | A | No leak even | D | Could be | C | 7 |
| | | when applying | | squeezed out | | |
| | | rather strong | | sufficiently | | |
| | | pressure to the | | with rather | | |
| | | filled bag | | strong | | |
| | | | | gripping force, | | |
| | | | | but not | | |
| | | | | smoothly | | |
| D | A | No leak even | D | Only some | D | 8 |
| | | when applying | | adults were | | |
| | | rather strong | | able to | | |
| | | pressure to the | | squeeze out by | | |
| | | filled bag | | strongly | | |
| | | | | gripping with | | |
| | | | | both hands. | | |
| | | | | Not practical. | | |
| D | A | No leak even | D | Difficult to | D | 9 |
| | | when applying | | squeeze out | | |
| | | rather strong | | even if an | | |
| | | pressure to the | | adult grips | | |
| | | filled bag | | very strongly | | |
| | | | | with both | | |
| | | | | hands | | |

In view of Table 2, the fusion bond strength of the samples belonging to rank 4 or 5 is preferable as the fusion bond strength of the sealing section 134 when the container for administering medication 100 is squeezed in one hand to break the fusion bond of the sealing section 134 and force out the suspension in the storage section 30.

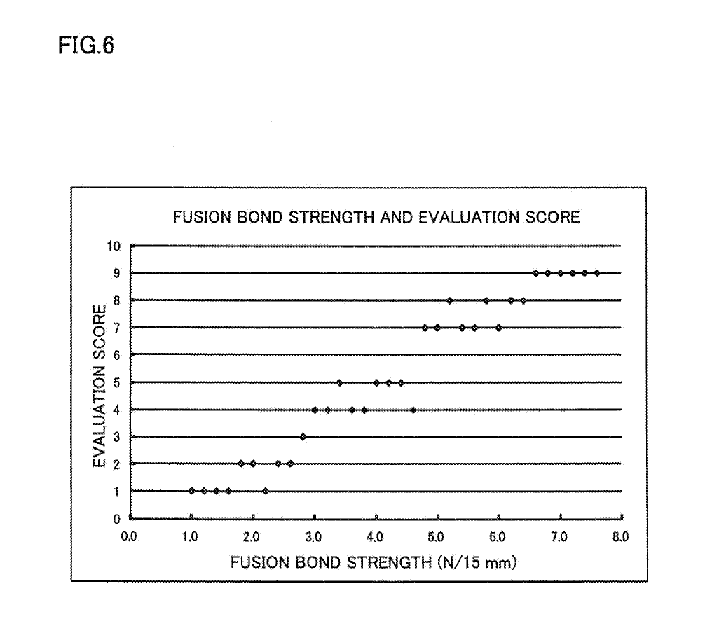

Next, the results of the general evaluation given to each sample are shown in FIG. 6. In view of FIG. 6, the samples belonging to ranks 4 and 5, in other words, the samples wherein the fusion bond strength of the sealing section 134 is 3.0-5.0 N/15 mm, exhibited extremely good results compared to the samples belonging to the preceding and subsequent evaluation ranks. Further, surprisingly, it was found that, when the fusion bond strength exceeds 5.0 N/15 mm, the fusion bond of the sealing section 134 cannot be broken smoothly, and it is impossible to discharge the liquid completely. It was also found that, if the fusion bond strength is 3.0 N/15 mm or lower, apart of the sealing section 134 breaks open and liquid leaks even when only light pressure is applied thereto. From the above, it is possible to judge that the fusion bond strength of the sealing section 134 is preferably 3.0-5.0 N/15 mm, which corresponds to ranks 4 and 5.

### Third Embodiment

The following explains the third embodiment of this invention.

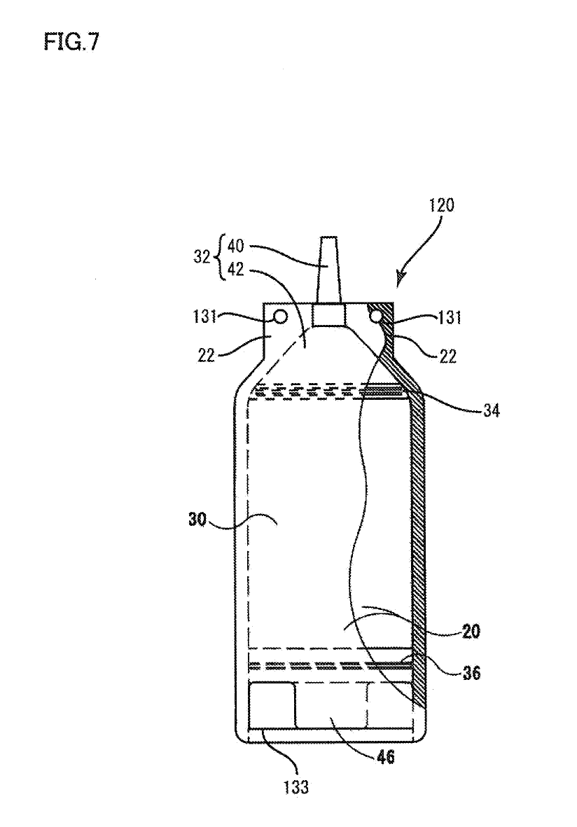

The container for administering medication 120 of the third embodiment will be explained using FIG. 7. The container for administering medication 120 has holes for storage 131 and an opening for folding 133 disposed on the container for administering medication 10 of the first embodiment. Two holes for storage 131 are formed on the outer circumference 22 in the vicinity of the portion where the connector 40 of the discharge section 32 and the sheets 20 are joined, with the connector 40 interposed therebetween. The opening for folding 133 is formed on the end that is not the end where the discharge section 32 is disposed. The opening for folding 133 is formed by the formation of a notch of a predetermined length in the sheets 20.

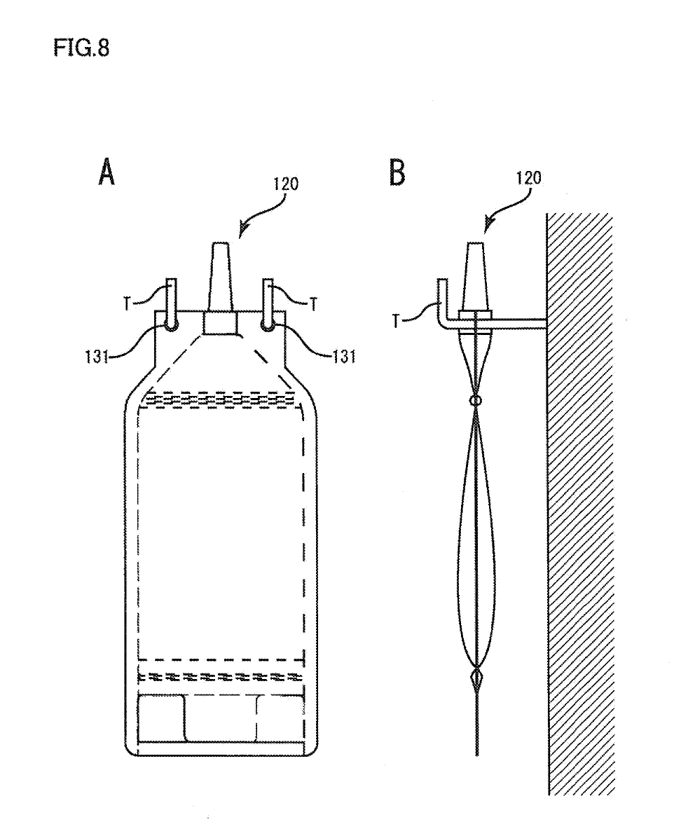

How the container for administering medication 120 is stored using the holes for storage 131 and the opening for folding 133, will be explained using FIGS. 8-10. FIG. 8 shows the container for administering medication 120 being stored in a suspended state, with A showing a front view and B showing a side view. The container for administering medication 120 is made by bonding two sheets 20 together and is thus a thin object. Therefore, it is unstable when the discharge section 32 is showing upward, and was difficult to store in this state. This is where, as shown in FIG. 8, predetermined storage protrusions T are inserted into the holes for storage 131 to store the container for administering medication 120 by suspending the container for administering medication 120 from the storage protrusions T. In this way, it is possible to store the container for administering medication 120 in a stable state, because the container for administering medication 120 can be stored in a suspended state due to the formation of the holes for storage 131. Note that the storage protrusions T are affixed to, for example, the surface of a wall.

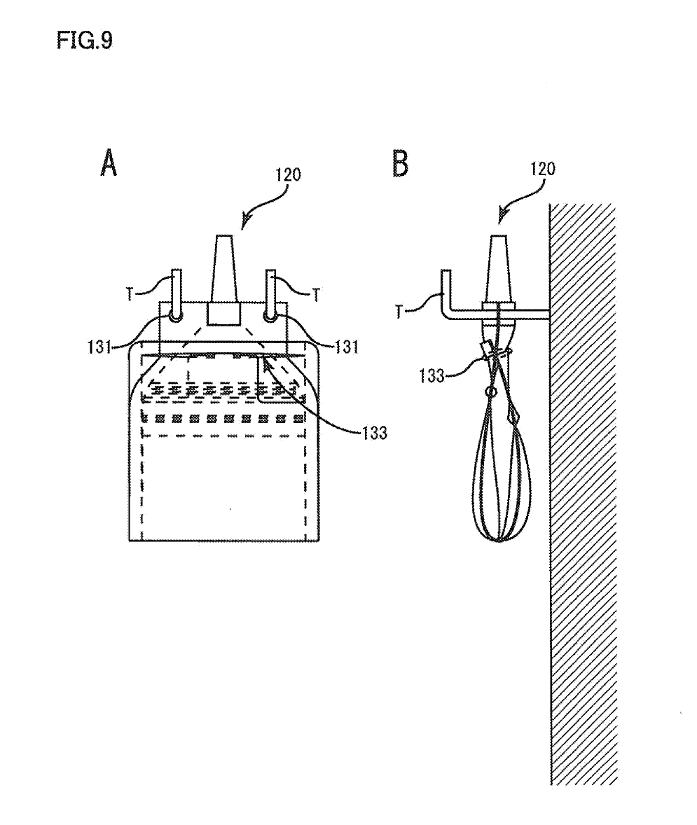

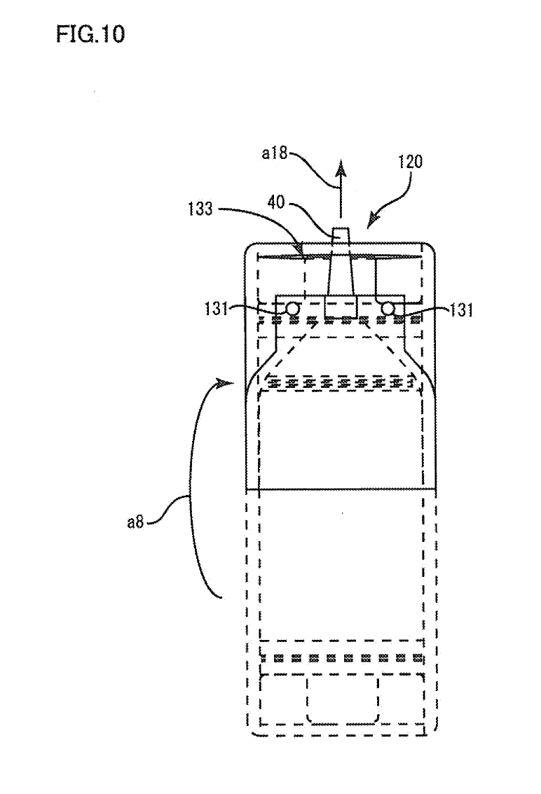

FIG. 9 shows the container for administering medication 120 being stored in a state of being suspended from the storage protrusions T while being folded into half, with A showing a front view and B showing a side view. It is possible to fold the container for administering medication 120 by inserting the connector 40 of the discharge section 32 into the opening for folding 133. As a result, it is possible to reduce the size of the container for administering medication 120 and store the container for administering medication 120 efficiently in a limited space. When folding the container for administering medication 120, the end on which the opening for folding 133 is formed, is moved toward the discharge section 32 (into the direction of the arrow a8), and the connector 40 of the discharge section 32 is inserted into the opening for folding 133, as shown in FIG. 10. Subsequently, the connector 40 is moved as if to be drawn out of the opening for folding 133 into the direction of the arrow a18 and disposed in a position that allows the storage protrusions T to be inserted into the holes for storage 131, as shown in FIG. 9A. As a result, it is possible to store the container for administering medication 120 by suspending same in a state of being folded into half.

### Explanation of Alternative Examples

The above-mentioned container for administering medication 10 is presented as an example to concretize the technical concept of this invention. Various changes within the scope of the technical concept of this invention may be applied thereto.

### First Alternative Example

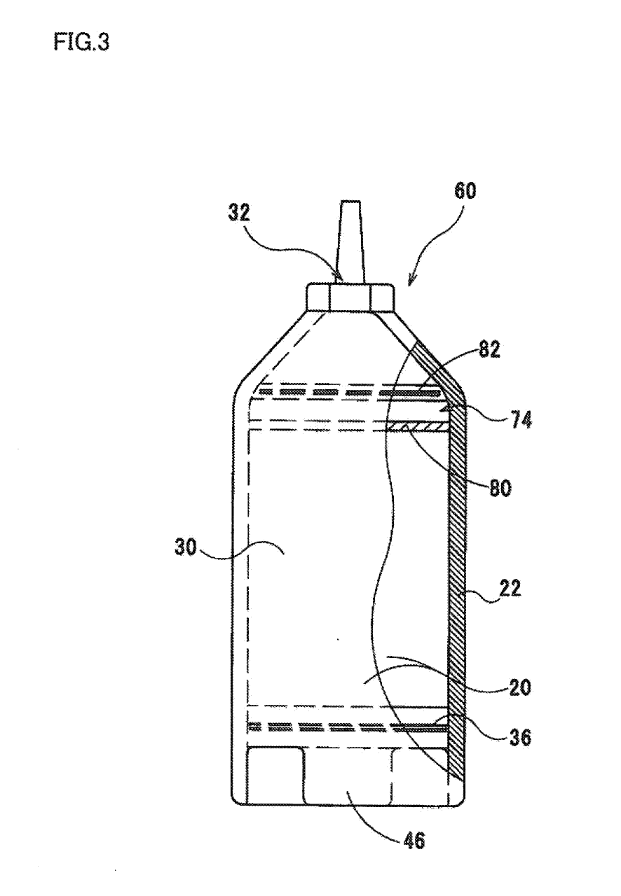

FIG. 3 is a partial cross section of the container for administering medication 60 of the first alternative example. The container for administering medication 60 of this alternative example is also formed by superposing the two sheets 20 and 20 on each other and bonding the outer circumferences 22 thereof to each other firmly in such a manner that the sheets do not easily detach.

The container for administering medication 60 of the first alternative example has a storage section 30, a discharge section 32, a sealing section 74 and an inlet opening/closing section 36 formed therein.

The sealing section 74 of the first alternative example has a fusion-bonded section 80 and a backup section 82. The fusion-bonded section 80 is made by fusion-bonding the surfaces of sheets 20 which face each other. When warm water is filled into the storage section 30 and a force of at least a predetermined strength is applied to the warm water from the outside of the storage section 30 in this state, the fusion-bonded section 80 opens by the force received from the warm water. The backup section 82 maintains the sealed state of the boundary portion between the storage section 30 and the discharge section 32 when the fusion-bonded section 80 came open. This means that the backup section 82 is positioned more to the side of the discharge section 32 than the position of the sealing section 74. In the case of this alternative example, the backup section 82 is composed of a zipper tape. The other features are the same as those of the above-mentioned container for administering medication 10, thus a detailed explanation thereof will not be repeated. According to the container for administering medication 60 of this alternative example, it is possible to suppress the risk that the mixture of the medicine and the warm water flows out of the discharge section 32 against the will of the nurse even if the fusion-bonded section 80 opens against the will of the nurse while the nurse forms cracks on the film of block-like medicine inside the storage section 30, because the backup section 82 is provided. Note that, in the case of this alternative example, the force required for the backup section 82 to open is slightly weaker than the force required for the fusion-bonded section 80 to open. If the force required for the backup section 82 to open is stronger than the force required for the fusion-bonded section 80 to open, it becomes necessary to apply even stronger force to the storage section 30 from the point of time when the fusion-bonded section 80 opens, when force was applied to open the sealing section 74. Meanwhile, the backup section 82 is required to maintain the sealed state if the fusion-bonded section 80 opened. Since it is necessary to achieve both, the force required for the backup section 82 to open is slightly weaker than the force required for the fusion-bonded section 80 to open.

### Second Alternative Example

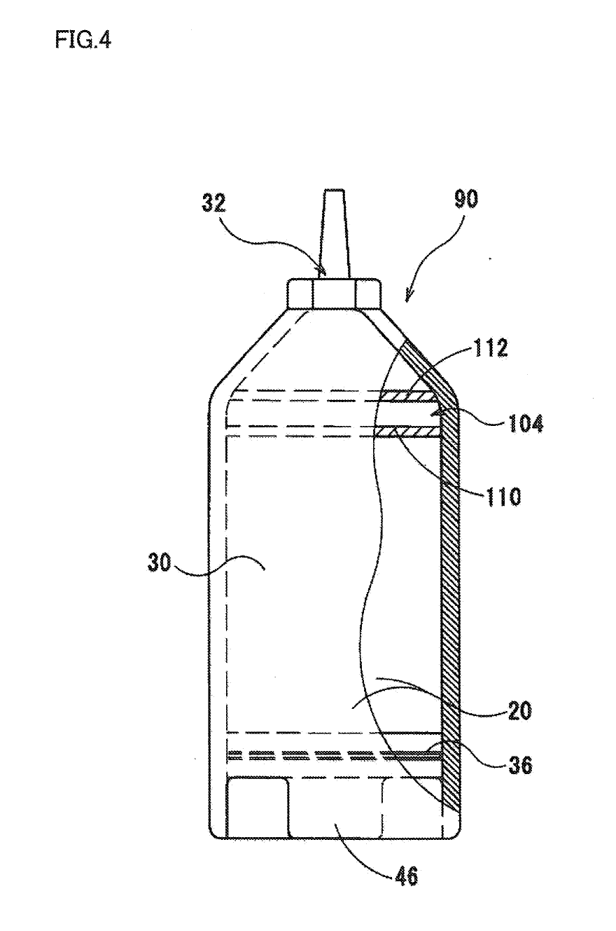

FIG. 4 is a partial cross section of the container for administering medication 90 of the second alternative example. The container for administering medication 90 of this alternative example is also formed by superposing the two sheets 20 and 20 on each other and bonding the outer circumferences 22 thereof to each other firmly in such a manner that the sheets do not easily detach.

The container for administering medication 90 of the second alternative example has a storage section 30, a discharge section 32, a sealing section 104 and an inlet opening/closing section 36 formed therein.

The sealing section 104 of the second alternative example has a fusion-bonded section 110 and a backup section 112. The fusion-bonded section 110 and the backup section 112 are both made by fusion-bonding the surfaces of sheets 20 which face each other. The fusion-bonded section 110 and the backup section 112 open by pressure received from warm water in the storage section 30. The other features are the same as those of the above-mentioned container for administering medication 10, thus a detailed explanation thereof will not be repeated. Note that, in the case of this alternative example, the force required for the backup section 112 to open is weaker than the force required for the fusion-bonded section 110 to open. The reason therefor is the same as the reason why the force required for the backup section 82 to open is slightly weaker than the force required for the fusion-bonded section 80 to open. According to the container for administering medication 90 of this alternative example, it is possible to suppress the risk that the mixture of the medicine and the warm water flows out of the discharge section 32 against the will of the nurse even if the fusion-bonded section 110 becomes detached against the will of the nurse while the nurse causes block-like medicine to become suspended inside the storage section 30, because the backup section 112 is provided. Further, one container for administering medication 90 of this alternative example is used for each administration of medication. As a result, if the container for administering medication 90 of this alternative example is used, it becomes unnecessary to clean the container for administering medication 90 and to store the container for administering medication 90 for reuse. Because the cleaning and storage for reuse become unnecessary, the worked involved with the cleaning and storage for reuse can be reduced.

### Other Alternative Examples

Further, the above-mentioned containers for administering medication 10, 60, 90, 100 and 120 are not limited to being formed by superposing two sheets 20 and 20 on each other and bonding the circumference thereof. For example, the containers for administering medication 10, 60, 90, 100 and 120 may be formed by folding one sheet into half and bonding the outer circumferential portions, or by bonding the inner surfaces of one synthetic resin tube to each other.

Further, scale marks to serve as a hint for the volume of the mixture inside the storage section 30 may be provided on the surface of the containers for administering medication 10, 60, 90, 100 and 120. In addition, a field to write the name etc. of the patient to whom the medicine is administered may be provided on the surface of the containers for administering medication 10, 60, 90, 110 and 120.

Moreover, in the aforementioned second embodiment, the preferable fusion bond strength of 3.0-5.0 N/15 mm of the sealing section 134 of the container for administering medication 100 may be applied to the engagement strength of the zipper tape of the sealing section 34 of the container for administering medication 10. The fusion bond strength of the sealing section 134 in the second embodiment is determined by the internal pressure of the storage section 30 and is believed to be not influenced by the structure of the sealing section. The same applies for the sealing section 74 and backup section 82 of the container for administering medication 60 and for the sealing section 104 and backup section 112 of the container for administering medication 90.

Further, the container for administering medication 120 of the third embodiment is obtained by forming holes for storage 131 and an opening for folding 133 on the container for administering medication 10, but the holes for storage 131 and the opening for folding 133 may also be formed on the container for administering medication 60, 90 or 110. Moreover, any one of the holes for storage 131 and the opening for folding 133 may be formed on the container for administering medication 60, 90, 110 or 120.

In addition, on the container for administering medication 120, the holes for storage 131 were formed in the periphery of the connector 40 of the discharge section 32, but the position where the holes for storage 131 are formed is not limited to the exemplified one. Further, two holes for storage 131 were formed in the container for administering medication 120, but the number of holes for storage is not limited to the exemplified one.

In addition, the opening for folding 133 of the container for administering medication 120 was formed by the formation of a notch in the sheet 20, but there is no limitation to the exemplified opening for folding as long as the opening for folding allows to insert the discharge section 32 and to fold the container for administering medication 120 into half. For example, a hole that allows the discharge section 32 to be inserted may be formed on the end that is not the end on which the discharge section 32 is formed.

### EXPLANATION OF THE REFERENCE NUMERALS

10, 60, 90, 100, 120: Container for administering medication
20: Sheet
22: Outer circumference
30: Storage section
32: Discharge section
34, 74, 104, 134: Sealing section
36: Inlet opening/closing section
40: Connector
42: Empty chamber
46: Inlet
50: Cutout
58: Tube
72: Partitioning portion
80, 110: Fusion-bonded section
82, 112: Backup section

1. A container for administering medication
comprising
a storage section having an inlet for a medicine and a liquid, and
a discharge section capable of discharging a mixture of said medicine and liquid,
wherein:
said container for administering medication further comprising a sealing section that seals the boundary portion between said storage section and said discharge section,
said sealing section opens said boundary portion when said storage section storing said mixture receives a force of at least a predetermined strength,
said discharge section can be connected to a tube,
said storage section has, in addition to said inlet, an inlet opening/closing section that opens and closes said inlet, and
said storage section is formed of a material that allows the application of concentrated external force to said medicine in said mixture while said mixture is being stored.

2. The container for administering medication described in claim 1, wherein:
the boundary portion between said storage section and said discharge section has a portion that is formed from sheets facing each other, and
said sealing section
has a first sealing section that seals the boundary portion between said storage section and said discharge section by means of the fusion-bonding of said surfaces of sheets that face each other.

3. The container for administering medication described in claim 1, wherein:
said sealing section
has a first sealing section that seals the boundary portion between said storage section and said discharge section by means of a zipper tape.

4. The container for administering medication described in claim 1, which has a second sealing section that is positioned more to said discharge section side than the position of said sealing section and maintains the sealed state of said boundary portion.

5. The container for administering medication described in claim 4, wherein:
said second sealing section
maintains the sealed state of said boundary portion by means of the fusion-bonding of the surfaces of said sheets that face each other.

6. The container for administering medication described in claim 4, wherein:
said second sealing section
maintains the sealed state of said boundary portion by means of a zipper tape.

7. The container for administering medication described in claim 1, wherein said inlet opening/closing section has a zipper tape.

8. The container for administering medication described in claim 2 wherein the surface of said sheet that is fusion-bonded is formed of a polyethylene material.

9. The container for administering medication described in claim 2, wherein:
the tear strength of the fusion bond between the surfaces of said sheets that face each other at said sealing section is 3.0-5.0 N/15 mm when measured according to JIS Z 0238.

10. The container for administering medication described in claim 1, which has a hole for storage for inserting a predetermined protrusion for storage.

11. The container for administering medication described in claim 1, which has a discharge-section insertion opening on the end at which said discharge section is not positioned.
